(19) United States
(12) Patent Application Publication
(10) Pub. No.: US 2005/0254080 A1
(43) Pub. Date: Nov. 17, 2005

(54) Print system having image forming device for reprinting document and method thereof

(75) Inventor: Kee-taek Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/125,342

(22) Filed: May 10, 2005

(30) Foreign Application Priority Data
May 14, 2004 (KR) 2004-34163

(51) Int. Cl. G06F 9/455; G06F 15/00; H04N 1/21

(52) U.S. Cl. 358/1.13; 358/1.16

(57) ABSTRACT

A print system, a terminal device and an image forming device therein are provided. The print system provides a document reprint function. When printing a document, data relating to the printed document is stored in the image forming device so as to reprint the document with a simple operation. The storing time for the document data in the image forming device can be set separately for the document. The user can change the storing period of the document data pre-stored in the image forming device. The terminal device provides a user interface window enabling the user to specify and change the document storing period.

### CROSS-REFERENCE TO RELATED APPLICATIONS

This application claims the benefit under 35 U. S. C. § 119(a) of Korean Patent Application No. 2004-34163 filed on May 14, 2004 in the Korean Intellectual Property Office, the entire disclosure of which is hereby incorporated herein reference.

### BACKGROUND OF THE INVENTION

1. Field of the Invention

The present invention generally relates to an image forming device having a reprint function and a reprint method thereof. More particularly, the present invention relates to an image forming device for setting different document storing periods for the data used for reprinting a document and storing the data, and changing the document storing periods of the stored data, and a method thereof.

2. Description of the Related Art

The recent advances in electronic technology and the prevalence of computers have led to the wider use of peripheral devices. A peripheral device is an outside computer device which enables various functions to be performed in relation with the computer. Examples of peripheral devices include scanners, printers, multifunction machines, and the like.

As for a printer, by way of example of the peripheral device, a user creates a document in an application program of a personal computer, and inputs a print command. A printer driver in the personal computer converts the created document to a printing language recognizable by the printer, and generates data to be printed. The printing data is transferred to the printer. The printer includes a control part and an engine part. The control part receives the printing data from the personal computer and converts the printing data to bitmap image data. The engine part prints the bitmap image data on a print medium, such as paper, under the control of the control part.

Several manufacturers are competitively developing such an image forming device as above, and users can purchase a number of diverse models of image forming devices for relatively low prices on the commercial market. Recent image forming devices have various functions, including a reprint function.

FIG. 1 is a flowchart of an operation to reprint a document by a conventional image forming device. Referring to FIG. 1, a user inputs a print command for a certain document. The personal computer converts the certain document to printing data formatted in a printing language, and transfers the printing data to the image forming device. Upon receiving the printing data (S10), the image forming device converts the print data to bitmap image data, which is preferably stored in a memory therein (S20). The image forming device controls specific mechanical units to print the bitmap image data on a print medium (S30).

If the user wants to reprint the certain document, the user has only to input a document reprint command without executing a related application. To this end, the user may input the reprint command through the personal computer or by means of an input means provided for the image forming device.

Upon receiving the reprint command for the certain document (S40), the image forming device checks whether the bitmap image data of the certain document is still stored in a memory (S50). If so, the bitmap image data of the certain document is read from the memory and reprinted on the print medium (S60).

As the memory has a limited capacity, the stored data is assigned with a certain storing period. To be specific, the image forming device stores a document in bitmap image data form together with information relating to a storing time and a storing period. When the storing period expires, the document bitmap image data and related information is deleted.

In the conventional image forming device mentioned above, the storing period is preestablished by a developer of the image forming device and applied to all documents. A storing period of the stored document cannot be changed. Thus, if the user wants to keep the document for a time longer than the specified storing period, the user has to execute the related application in another personal computer and input a print command again, which is cumbersome. Furthermore, the document is stored for a predetermined period whether the user wants to store the document for a shorter term or for a few days, and thus unnecessarily occupies the memory capacity.

### SUMMARY OF THE INVENTION

Embodiments of the present invention have been developed in order to solve the problems discussed above and others associated with the conventional arrangement. An aspect of the embodiments of the present invention provides a print system for setting a storing period different for each document and reprinting a document upon receiving a reprint command within a storing period, an image forming device and a method thereof.

Another aspect of the embodiments of the present invention provides a print system for changing a preset storing period, an image forming device and a method thereof.

To achieve the above aspects of the embodiments of the present invention, a print system comprises a terminal device for outputting document storing period information and printing data with respect to a document when a print command for the document is input; and an image forming device for printing the printing data on a print medium, such as paper, when the document storing period information and the printing data are received from the terminal device, and storing the document in a certain data form for the document storing period.

The terminal device comprises an application part for supporting a preparation function and a print function for the document; and a driver part for converting the document prepared in the application part to the printing data by use of a certain emulation language, and displaying a first user interface window to set a document storing period of the document on a display screen.

The driver part displays a second user interface window to change a document storing period of a document pre-stored in the image forming device on the display screen.

The image forming device comprises a controller for converting the printing data to certain image data, an engine part for printing the document on a print medium, such as paper, according to the image data, and a memory for storing the document as the printing data or preferably as the bitmap image data for the document storing period. Accordingly, the controller can control the engine part to reprint the document by reading the data stored in the memory when a reprint command for the document is received.

The image forming device further comprises a key signal input part for receiving an external control signal; and a display for displaying a certain warning message. The controller controls the display of certain warning messages through the display or the terminal device when it is determined that the document storing period for the document in a certain form stored in the memory has expired, and when the document storing period is changed by the key signal input part or the terminal device, the controller retains the document in the memory for the extended document storing period.

A terminal device to print a certain document using an image forming device, comprises an application part for supporting a preparation function and a print function for the document; and a driver part for converting the document prepared in the application part to printing data using a certain emulation language, displaying on a display screen a first user interface window to set a document storing period of the document, and transferring to the image forming device document storing period information set through the first user interface window and the printing data.

The driver part displays a second user interface window to change a document storing period of a document pre-stored in the image forming device on the display screen, and when the document storing period is changed through the second user interface window, the driver part transfers the changed document storing period information to the image forming device.

Consistent with the above aspect of an embodiment of the present invention, an image forming device comprises an interface for receiving from a terminal device printing data of a document and document storing period information which is set separately for the document; a controller for converting the printing data received through the interface to certain image data; a memory for storing the document in a certain data form for the document storing period; and an engine part for printing the document on a print medium, such as paper, according to the certain image data.

The controller controls the engine part to reprint the document by reading the data stored in the memory when a reprint command for the document is received.

The controller controls the memory to store the document for a changed document storing period when the changed document storing period information of the document is received from the terminal device.

The controller checks a real storing time of the document by comparing a time when the document is stored in the memory with current time information, and determines whether the document storing period has expired by comparing the real storing period (the amount of time the document has been stored) and the document storing period.

The image forming device further comprises a key signal input part for receiving an external control signal; and a display for displaying a certain message. The controller sends a warning message that is displayed through the display or the terminal device when it is determined that the document storing period of the document has expired, and when the document storing period is changed by the key signal input part or the terminal device, the controller controls the retention of the document for the extended document storing period.

Consistent with the above aspects of embodiments of the present invention, a print method of an image forming device, comprising the steps of (a) converting a document to certain printing data when a print command for the document is received; (b) setting a document storing period of the document; (c) converting the printing data to certain image data; (d) printing the document on a paper according to the image data; and (e) storing the document in a certain form of data for the document storing period.

The print method further comprises receiving a reprint command for the document; and reading and reprinting the stored document.

Step (e) comprises the sub-steps of determining whether the document storing period of the document is expired; displaying a warning message to indicate the expiration of the document storing period when the document storing period is expired; displaying a user interface window enabling change of the document storing period when it is requested to change the document storing period; and changing the document storing period of the document to the changed document storing period set through the user interface window.

In step (e), a real storing time of the document is checked by comparing a time when the document is stored in the memory with current time information, and determines whether the document storing period is expired by comparing the real storing period (the amount of time the document has been stored) and the document storing period.

The print method further comprises the steps of receiving a request to change a document storing period of a pre-stored document; displaying a user interface window enabling a user to change the document storing period; and storing the document for a document storing period changed through the user interface window.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 is a flowchart of a document reprint operation of a conventional image forming device;

FIG. 2 is a block diagram of a print system according to an embodiment of the present invention;

FIG. 3 is a user interface window for setting a document storing period according to an embodiment of the present invention;n;

FIG. 4 is a user interface window for changing a document storing period according to an embodiment of the present invention;

FIG. 5 is a flowchart of an print operation of the print system of FIG. 2; and

FIG. 6 is a flowchart of a reprint operation of an image forming device of the print system of FIG. 2.

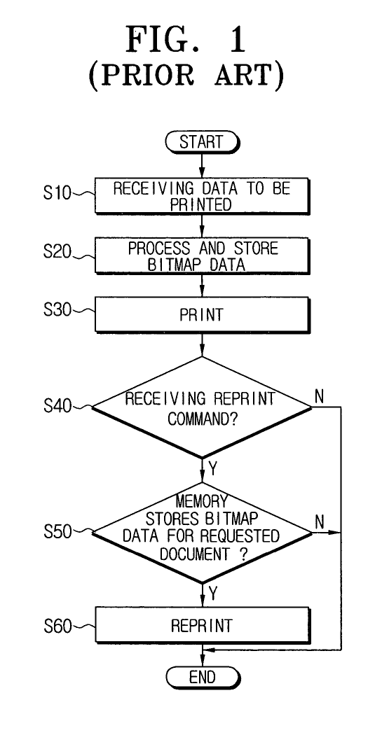

Throughout the drawings, it should be understood that like reference numbers refer to like features, structures and elements.

### DETAILED DESCRIPTION OF EXEMPLARY EMBODIMENTS

Exemplary embodiments of the present invention will now be described in more detail with reference to the accompanying drawings.

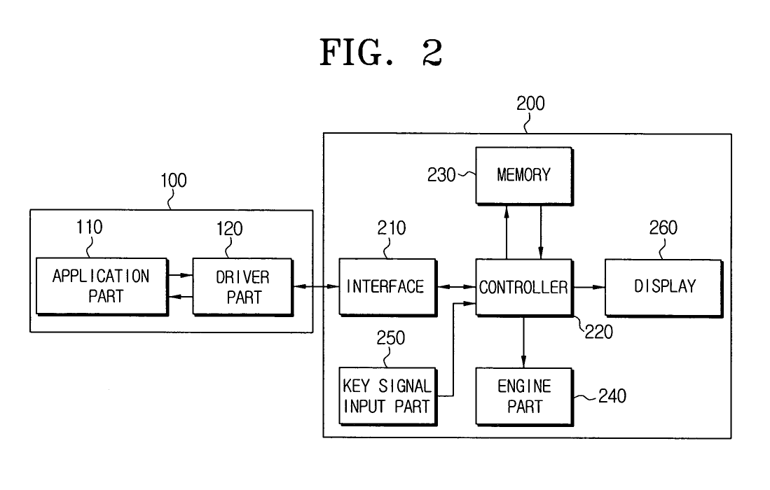

FIG. 2 is a block diagram of a print system according to an embodiment of the present invention. In FIG. 2, the print system comprises a terminal device 100 and an image forming device 200. The terminal device 100 comprises an application part 110 and a driver part 120. The image forming device 200 includes an interface 210, a controller 220, a memory 230, an engine part 240, a key signal input part 250, and a display 260.

A user can prepare a document and inputs a print command using the application part 110 of the terminal device 100. The terminal device 100 can be an electronic device such as a personal computer, a notebook, or a personal digital assistant (PDA). In the case of a personal computer, various word processor programs, such as Word® or Word Perfect®, can be the application part 110.

When the user inputs the print command for the prepared document, the driver part 120 converts the document to data to be printed using a certain emulation language. The driver part 120 enables the terminal device 100 to recognize and communicate with the image forming device 200 being connected. If the image forming device 200 is a laserjet printer, the emulation language can be Printer Command Language (PCL) 4 and PCL 5 from Hewlett-Packard, and PostScript from ADOBE.

The interface 210 provides a data path between the image forming device 200 and the terminal device 100.

The controller 220 converts the printing data to certain bitmap image data by processing the printing data, for example, rendering the printing data received through the interface 210. The controller 220 controls the engine part 230 to perform the printjob according to the bitmap image data. The engine part 240 is a mechanical unit that prints an image on a print medium, such as paper. As for a laserjet printer, the engine part 240 can comprise a photoconductive drum, a charging unit, a laser scanning unit (LSU), a transfer unit, a developing unit, a feeding unit and a discharge unit (not shown).

The key signal input part 250 receives a control signal that the user generates by manipulating buttons provided to a main body of image forming device 200, and sends the received control signal to the controller 220.

The user may select a specific document and input a reprint command for the specific document through the key signal input part 250 or using a user interface window provided by the driver part 120 of the terminal device 100. The reprint command for a document is an order to reprint the document preferably using the bitmap image data of the document that has been printed.

To reprint the document, the controller 220 stores the document in a certain data format in the memory 230. Even if the memory 230 can store the printing data received from the terminal device 100, it is advantageous to store the document in bitmap image data form so as not to have to re-render the data. The bitmap image data may be compressed and stored to reduce a size of the data to save space in the memory 230.

Upon receiving the reprint command, the controller 220 reads the bitmap image data from the memory 230 and sends the read bitmap image data to the engine part 240 to reprint the document on paper.

When the user inputs the print command in the application part 110, the driver part 120 displays a user interface window enabling the user to set print options including the number of copies and a first page to be printed. An additional menu can be displayed allowing the user to select whether to store the document. In this situation, another additional menu is preferably displayed to set a document storing period. If the user does not set the document storing period, the document storing period is set to a default value.

Information relating to the set document storing period is transferred to the image forming device 200 and stored in the memory 230 together with the corresponding data. The memory 230 records a time when the corresponding data is stored, that is, a print time so that the controller 220 can confirm whether the document storing time has expired. In further detail, a timer (not shown) monitors the time when the data is stored in the memory 230, and the beginning of the document storing period. When the document storing period expires, an interrupt signal is sent to the controller 220 to notify the controller 220 of the expiration of the document storing period. The controller 220 can periodically monitor the storing time and the document storing period with respect to the data stored in the memory 230, compare them with a current time, and determine the expiration or availability of the document storing period.

Upon determining the expiration of the document storing period, the controller 220 signals the display 260 to display a certain warning message. The display 260 also displays the various statuses of the controller 220. Typically, the image forming device 200 implements the display 260 by means of a liquid crystal display (LCD) panel or a light emitting diode (LED). If the image forming device 200 is provided with hardware, such as a LCD panel, capable of showing a file name, the file name is displayed so that the user can determine whether to reset or to leave the document storing time to be deleted. Upon determining the expiration of the document storing period, the controller 220 notifies the driver part 120 of the expiration so as to display the warning message on a screen of the terminal device 100. Alternatively, the controller 220 may automatically delete the document without displaying a warning message.

The user can change the document storing period of a document pre-stored in the image forming device 200 by use of the terminal device 100. To this end, the driver part 120 provides an additional user interface window. To be specific, if it is determined that the memory 230 of the image forming device 200 lacks storage capacity, the pre-stored document can be deleted in the additional user interface window provided by the driver part 120. If the user wants to check documents stored in the image forming device 200 and extend their storing periods, the user can change the document storing periods directly using the user interface window.

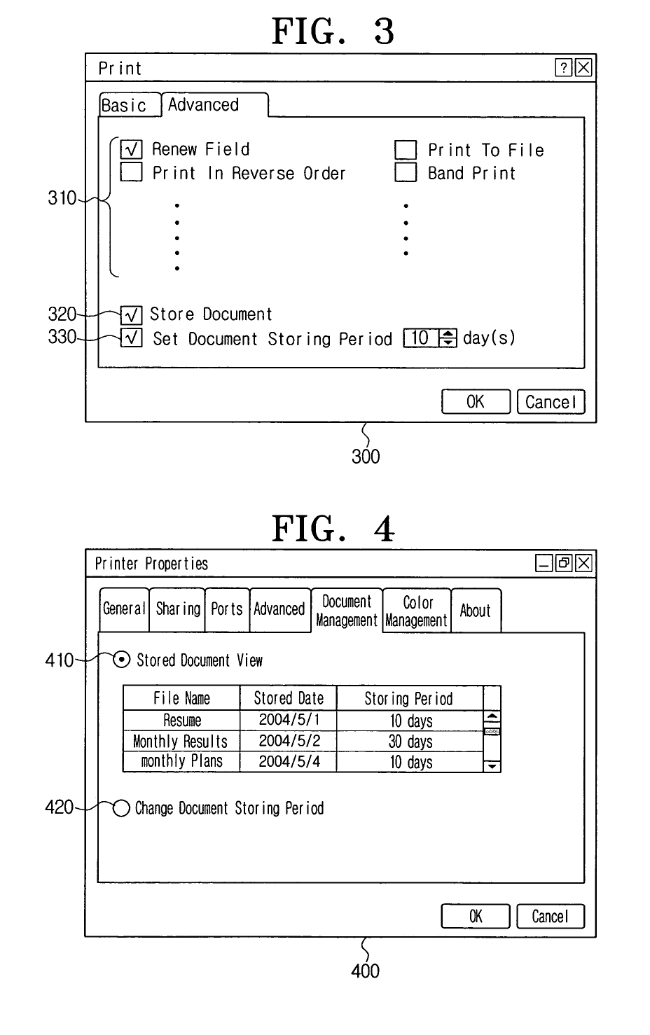

FIG. 3 illustrates an example of a user interface window 300 having a menu to set the document storing period according to an embodiment of the present invention. When the user prepares a document and inputs a print command, the driver part 120 displays the user interface window 300 on a screen to set print options. In FIG. 3, the user interface window 300 indicates general menus 310 together with a ‘store document’ menu 320 and a ‘set document storing period’ menu 330 for the sake of the reprint job. If the user selects the ‘store document’ menu, the ‘set document storing period’ menu is automatically activated so that the user can set a certain value by manually inputting a number, using a spin button, or other means of setting the value. Although the ‘set document storing period’ menu 330 is also shown in the user interface window of FIG. 3, it is possible to set the document storing period by displaying an additional user interface window upon selecting the ‘store document’ menu 320.

FIG. 4 illustrates an example of a user interface window 400 having a menu to change a document storing period. In FIG. 4, the user interface window 400 additionally shows a ‘stored document view’ menu 410 that presents information relating to the stored document in the image forming device 200 and a ‘change document storing period’ menu. If it is requested to change the document storing period from the terminal device 100, the image forming device 200 transfers the information relating to the stored document in the memory 230. The driver part 120 displays the received document information on the user interface window 400. The document information preferably comprises a document name, a stored time, and a storing period as shown in FIG. 4. Accordingly, the user can change the document storing period of each document by selecting the ‘change document storing time’ menu 420.

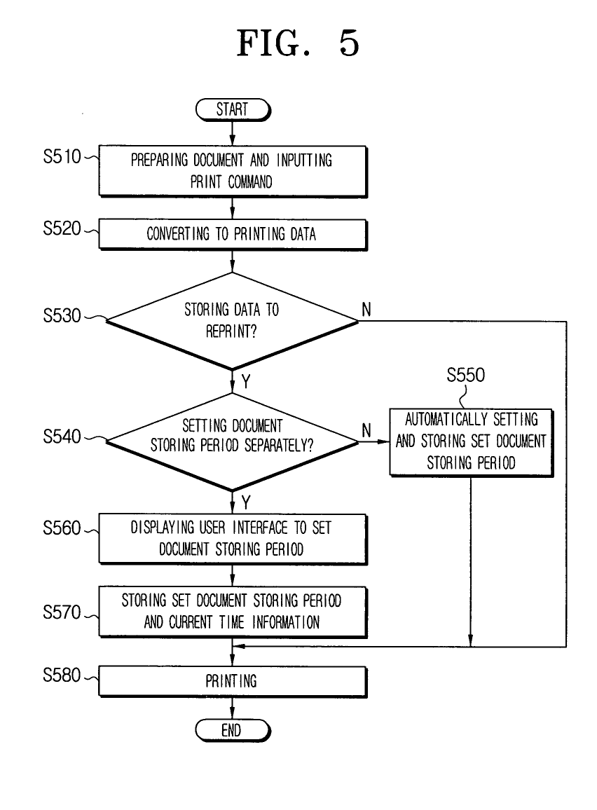

FIG. 5 illustrates a print operation of the print system according to an embodiment of the present invention. Referring to FIG. 5, the user prepares a document using the application part 110 in the terminal device 100 and inputs a print command (S510).

The driver part 120 prepares data to be printed with a certain emulation language recognizable by the controller 220 of the image forming device 200 (S520).

Upon receiving the print command, the driver part 120 displays a user interface window on a screen for selecting print options. It is confirmed whether the user selects the document storing function for the reprint in the user interface window (S530). If so, it is confirmed whether it is requested to set the document storing period separately (S540).

Upon determining that a request to set the document storing period has been made, an additional user interface window is displayed so that the user can specify the document storing period as shown in FIG. 5 (S560). The document storing period may be set in the user interface window displayed upon the input of the print command as shown in FIG. 3. It is to be understood that the user interface window can be designed and generated by a developer based on features that are most convenient to a user.

When the user selects to store the document but does not specify the document storing period separately, the document storing period is automatically set to a preestablished default value, transferred to and preferably stored in the image forming device 200 together with the printing data (S550).

When the user specifies the document storing period, information relating to the set document storing period is preferably transferred to the image forming device 200 (S570). The image forming device 200 stores the printing data, the information relating to the set document storing period, and the current storing time in the memory 230. In this operation, the image forming device 200 may store the printing data to be reprinted, or, when the controller 220 converts the printing data to certain bitmap image data, the image forming device 200 may store the bitmap image data with or without the bitmap image data being compressed.

The image forming device 200 preferably performs the printjob according to the converted bitmap image data (S580).

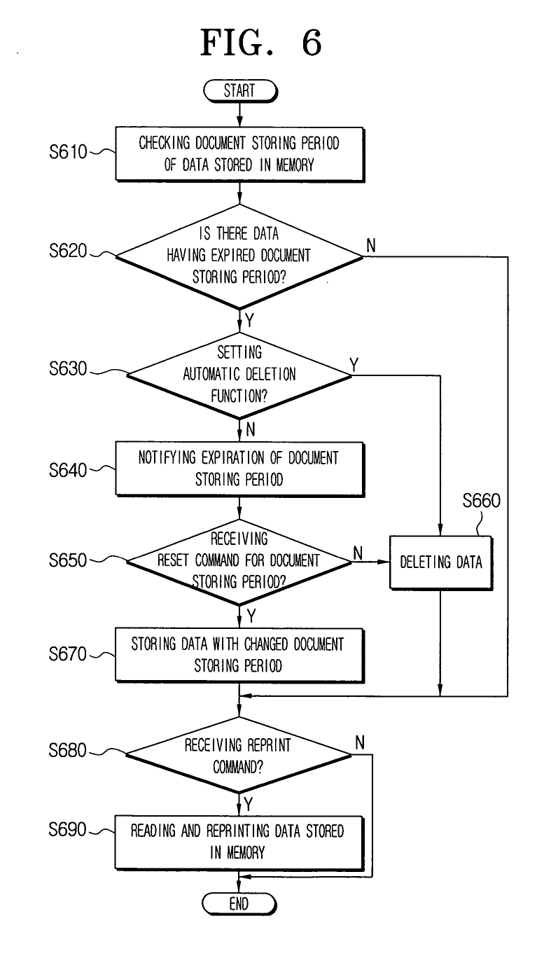

FIG. 6 is a flowchart of a reprint operation of the image forming device 200 of the print system of FIG. 2. Referring to FIG. 6, the controller 220 of the image forming device 200 checks out the document storing period of the data stored in the memory 230 (S610). The controller 220 can determine the expiration or the availability of the document storing period by monitoring the data stored in the memory and the set document storing period at certain time intervals and comparing the added time with the current time information. Otherwise, the controller 220 can count the storing time of data by use of a separate timer, send an interrupt signal to the controller 220 upon the expiration of the document storing period, and thus determine whether the document storing period is expired.

If it is determined that there is data with an expired document storing period (S620), it is confirmed whether a function to automatically delete the data is set (S630). If so, the data is deleted from the memory 230 (S660).

When the automatic deletion function is not set, a warning message is displayed on a screen indicating the document name and the expiration of the data (S640). The warning message can be transferred to the terminal device 100 through the interface 120 and displayed on the screen of the terminal device 100 or through the display 260.

When the user inputs a reset command to reset the document storing period and specifies a new document storing period (S650), the document storing period stored in the memory 230 is extended according to the changed document storing period (S670).

When the reset command is not received from the user after a predetermined time, the data is automatically deleted (S660).

When the reprint command is input from the terminal device 110 or the key signal input part 250 (S680), the reprint job is performed by reading the data stored in the memory 230 (S690). As a result, the user can conveniently reprint the intended document with convenience.

Meanwhile, if a request is received from the terminal device 110 to change the document storing period of the stored document, the image forming device 200 transfers information relating the stored document in the memory 230, such as document name, a stored time, and/or a document storing period, to the terminal device 100.

The driver part 120 of the terminal device 100 displays the received document information in the user interface window so that the user can change the document storing period. Information about the changed document storing period is transferred to the image forming device 200 to change the document storing period stored in the memory 230.

In light of the foregoing as explained above, when storing a document in the image forming device for the reprint job, the document storing period can have various settings. Thus, it is possible to efficiently use memory capacity in consideration of the reprint characteristics of the document. Furthermore, since the document storing period of the stored document can be changed through a simple operation, the stored document is retained in the image forming device without having to open the stored document from a terminal device by executing a computer application part. Accordingly, the user can conveniently utilize the document reprint function of the image forming device.

While the exemplary embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

1. A print system comprising:
a terminal device for outputting document storing period information and printing data with respect to a document when a print command for the document is input; and
an image forming device for printing the printing data on a print medium when the document storing period information and the printing data are received from the terminal device, and storing the document in a certain data form for the document storing period.

2. The print system according to claim 1, wherein the terminal device comprises:
an application part for supporting a print function for the document; and
a driver part for converting the document to printing data by use of a certain emulation language, and displaying a first user interface window to set a document storing period of the document on a display screen.

3. The print system according to claim 2, wherein the driver part displays a second user interface window to change a document storing period of a document pre-stored in the image forming device on the display screen, and when the document storing period is changed through the second user interface window, the driver part transfers the changed document storing period information to the image forming device.

4. The print system according to claim 3, wherein the image forming device comprises:
an engine part for printing the printing data on the print medium;
a memory for storing the printing data in a certain data form; and
a controller for controlling the memory to retain the document for the document storing period when the document storing period information of the document is received from the terminal device.

5. The print system according to claim 4, wherein the image forming device further comprises:
a key signal input part for receiving an external control signal; and
a display for displaying a certain warning message, and
the controller controls to displays the certain warning message through the display or the terminal device when it is determined that the document storing period of the certain form of the document stored in the memory is expired, and when the document storing period is changed by the key signal input part or the terminal device, the controller controls to retain the certain form of the document in the memory for the extended document storing period.

6. A terminal device to print a certain document using an image forming device, comprising:
an application part for supporting a print function for the document; and
a driver part for converting the document to printing data by use of a certain emulation language, displaying a first user interface window to set a document storing period of the document on a display screen, and transferring to the image forming device document storing period information set through the first user interface window and the printing data.

7. The terminal device according to claim 6, wherein the driver part displays a second user interface window to change a document storing period of a document pre-stored in the image forming device on the display screen, and when the document storing period is changed through the second user interface window, the driver part transfers the changed document storing period information to the image forming device.

8. An image forming device comprising:
an interface for receiving from a terminal device printing data of a document and document storing period information which is set separately for the document;
a controller for converting the printing data received through the interface to certain image data;
a memory for storing the document in a certain data form for the document storing period; and
an engine part for printing the document on a paper according to the image data,
wherein the controller controls the engine part to reprint the document by reading the data stored in the memory when a reprint command for the document is received.

9. The image forming device according to claim 8, wherein the controller controls the memory to retain the document for a changed document storing period when the changed document storing period information of the document is received from the terminal device.

10. The image forming device according to claim 9, wherein the controller checks a real storing time of the document by comparing a time when the document is stored in the memory with current time information, and determines whether the document storing period is expired by comparing the real storing period and the document storing period.

11. The image forming device according to claim 10, further comprising:
a key signal input part for receiving an external control signal; and
a display for displaying a certain message,
wherein the controller controls to displays a warning message through the display or the terminal device when it is determined that the document storing period of the document is expired, and when the document storing period is changed by the key signal input part or the terminal device, the controller controls the retention of the document for the extended document storing period.

12. A print method of an image forming device, comprising the steps of:
(a) converting a document to certain printing data when a print command for the document is received;
(b) setting a document storing period of the document;
(c) converting the certain printing data to certain image data;
(d) printing the document on a print medium according to the certain image data; and
(e) storing the document in a certain form of data for the document storing period.

13. The print method according to claim 12, further comprising the steps of:
receiving a reprint command for the document; and
reading and reprinting the stored document.

14. The print method according to claim 12, wherein step (e) comprises the sub-steps of:
determining whether the document storing period of the document is expired;
displaying a warning message to notify the expiration of the document storing period when the document storing period is determined to be expired;
displaying a user interface window enabling to change the document storing period when it is requested to change the document storing period; and
changing the document storing period of the document to the changed document storing period set through the user interface window.

15. The print method according to claim 14, wherein step (e) further comprises the step of:
checking a real storing time of the document by comparing a time when the document is stored in the memory with current time information, and determines whether the document storing period is expired by comparing the real storing period and the document storing period.

16. The print method according to claim 12, further comprising the steps of:
receiving a request to change a document storing period of a pre-stored document;
displaying a user interface window enabling to change the document storing period; and
storing the document for a document storing period changed through the user interface window.
